(19) United States
(12) Patent Application Publication
(10) Pub. No.: US 2009/0219160 A1
(43) Pub. Date: Sep. 3, 2009

(54) Marine personnel safety system

(76) Inventors: Richard Clayton Shervey, Prince George (CA); John DaSilva, Prince George (CA)

Correspondence Address: Antony C. Edwards, P.O. Box 26020, Westbank, BC, V4T 2G3, CA

(21) Appl. No.: 12/379,043

(22) Filed: Feb. 11, 2009

Related U.S. Application Data
(60) Provisional application No. 61/064,009, filed on Feb. 11, 2008.

(51) Int. Cl. G08B 23/00

(52) U.S. Cl. 340/573.6

(57) ABSTRACT

A person-overboard monitoring and alarm system, includes an RFID tag worn by a user; an array of directional antennas for mounting around a perimeter of a boat hull, below and substantially parallel with a gunnel of the boat so as to be arrayed substantially above a water line of the boat and so as to provide a corresponding array of substantially distinct and independent detection zones which are substantially only directed outwardly of the boat, a transceiver cooperating with said array of antennas for detecting the presence of a tag in any one of said detection zones, a processor cooperating with said transceiver for receiving signals from said transceiver upon detection of said tag in said any one of said detection zones and determining which of said detection zones contain said tag, and wherein said processor is adapted to output an alarm trigger signal to an alarm upon said detection, whereby said antenna and said transceiver substantially only detects said tag when located over-board from the boat.

### CROSS REFERENCE TO RELATED APPLICATION

This application claims priority from U.S. Provisional Patent Application No. 61/064,009 filed Feb. 11, 2008 entitled Marine Personnel Safety System.

### FIELD OF THE INVENTION

This invention relates to the field of devices insuring personnel safety, and in particular to a method and apparatus employing radio frequency identification for identifying and locating the presence of a person in the water proximate to a boat.

### BACKGROUND OF THE INVENTION

Shipboard safety is of great importance. It is well known that a person falling overboard is at risk of drowning or other life threatening consequences. In many situations, these risks increase with the time that the person is in the water.

A person overboard condition can include the loss of a vessel's personnel, crew, passengers and/or cargo. A significant danger in traveling by water is the loss of life and property due to the loss of persons or articles which fall overboard from a vessel. It is not uncommon, especially on large vessels, for a person-overboard to remain unnoticed for a significant period of time. The likelihood of successful rescue decreases significantly if a man-overboard is not located soon after entering the water. The length of time and urgency of rescue is affected by many factors, including sea temperature, predator infestation and weather. Previous attempts to detect and locate a person overboard have not been satisfactory.

In particular, previous systems such as U.S. Pat. No. 6,057,759 to Marsh, often include a transmitter worn by a person in continuous or regularly intermittent communication with the onboard system. Such systems suffer from two significant problems. Firstly, as the transmitter is in continuous or intermittent communication with the onboard system, the battery life of the transmitter may be adversely affected due to the transmitter being active and transmitting when it is not necessary to do so, such as when the person is performing normal operations on the ship. Secondly, due to the steel construction of many ships, the communication with the transmitter may be interfered with in some areas of the ship interior thereby requiring extensive sensor antennas in most areas of this ship to permit the onboard system to adequately detect the person in these areas. Such extensive antennas are expensive and time consuming to install in a ship and do not significantly enhance the ability of the system to detect a person overboard condition.

Furthermore, other previous systems have included sensors in the transmitter worn by the person to sense water to turn on the radio system. Such systems may be prone to false person-overboard readings on stormy days or with sailboat operation. In particular, what is missing in the prior art, is a radio-frequency identification based personnel safety system for use in marine settings to detect the presence of a person-overboard condition and to determine the location of the person overboard where any transmitter worn by the person is not activated unless the person is in the water proximate to the boat.

As reported by Chen et al. in U.S. Pat. No. 6,853,303 which issued Feb. 8, 2005, for an RFID System and Method for Ensuring Personnel Safety, RFID Devices are low-cost, passive “smart” chips or “tags” that can be embedded in or attached to articles, products, and the like, to convey information about a product via a scanner. The smart tags may be generally small labels or the like with a miniature embedded antenna. The tags may be passive or active, the active tags requiring an internal power supply. A reader or scanner interrogates the smart tag with an electronic “trigger” signal. The tag in turn generates an electromagnetic pulse response that is readable by the scanner, the response containing the product information.

Various commercial applications have been suggested for smart tags, particularly in the area of retail marketing and sales. For example, RFID technology may be used to gather information related to consumer trends, purchasing habits, consumption rates, etc. It has also been suggested that RFID technology has promise in the areas of inventory control, manufacturing process and control, product accountability and tracking systems, etc. Manufacturers, shippers, and retailers may be able to follow a given product through their respective systems from initial production through to point of sale.

Chen et al. teach the use of identification smart tags with protective articles, such as protective clothing, eyewear, vests, face-masks, assisted. breathing devices, and the like, and scanning personnel using such articles to thereby ensure that the personnel are properly outfitted with the necessary safety equipment.

As discussed by Eckstein et al. in U.S. Pat. No. 6,894,614 which issued May 17, 2005, for a Radio Frequency Detection and Identification System, some RFID systems operate with resonant tags for identifying articles to which the resonant tag is attached or the destination to which the articles should be directed. It is taught that the use of resonant circuit tagging for article identification is advantageous compared to optical bar coding in that it is not subject to problems such as obscuring dirt and may not require exact alignment of the tag with the tag detection system, and that typically, systems utilizing multiple tuned circuit detection sequentially interrogate each resonant circuit with a signal having a frequency of the resonant circuit and then wait for reradiated energy from each of the tuned circuits to be detected.

### BRIEF DESCRIPTION OF THE DRAWINGS

FIG. 1 is a schematic view of an RFID transponder tag and the corresponding RFID transponder detection system.

FIG. 2 is a side perspective view of a boat having an antenna system according to one aspect of the present invention.

FIG. 3 is a top perspective view of the boat of FIG. 2.

FIG. 4 is a cross section view of a portion of the hull of the boat of FIG. 2 showing the antenna mounted to the hull of the boat above the waterline.

FIG. 5 is a front view of a launchable safety pod system having a radio pod and a wearable life preserver.

FIG. 6 is a front view of the safety pod system of FIG. 5 in a deflated and compacted configuration for launching by a launcher.

FIG. 7 is a detailed view of the life preserver of FIG. 5 having two leg holes and an inflation cord.

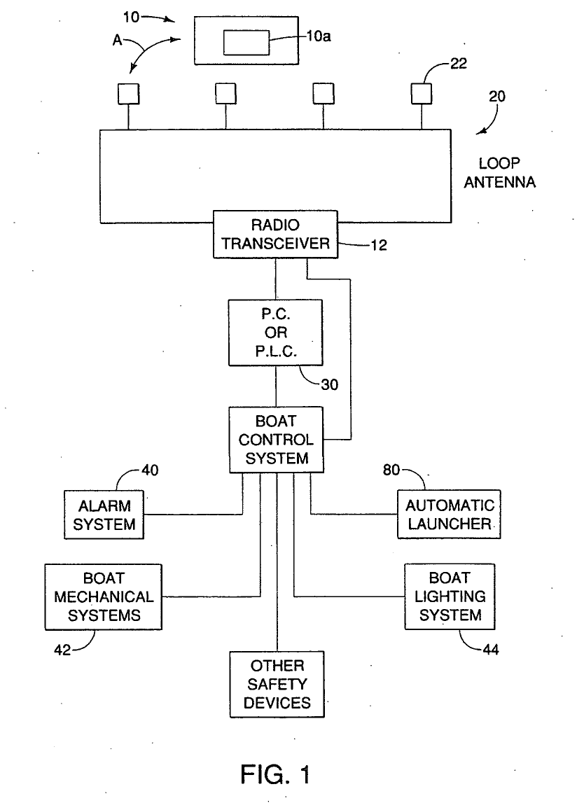

### DETAILED DESCRIPTION OF EMBODIMENTS OF THE INVENTION

As seen in the accompanying Figures, wherein similar characters of reference denote corresponding parts in each view, the RFID based marine personnel safety system according to one aspect of the present invention includes an RFID tag 10 which contains a transponder 10a. The tag may for example be worn by a person either on an item of clothing, as a wrist or necklace tag or the like. The onboard system includes a transceiver 12 having a plurality of antennae 22.

The transceiver 12 generates an interrogatory signal that is transmitted by at least one of the plurality of antenna 22 in a detection zone 23 defined by that antenna 22. This signal activates the transponder 10a, which is of appropriate frequency and power to activate a transponder within the desired detection ranges.

The RFID tag 10 may be an active, passive or semi-passive tag which is designed to only send a signal to the transceiver 12 when activated by the antennae 22. Accordingly, the RFID tag 10 will not transmit any signals when the wearer is on board the boat performing normal duties. The RFID tags 10 used for the present system will be small enough for wearer to be discreet such as for example dog tags or wrist bands. The RFID tags 10 may optionally have an antenna incorporated into the strap to hang around the neck and provide 360 degree coverage. Advantageously, the antennas may be small and incorporated into workers clothing or other attire, wherein the antennas are mounted front and back high on the worker's torso or upwards from there to provide un-attenuated three hundred sixty degree coverage. The RFID tags 10 may have a solar collector fitted to ensure batteries are charged and will preferably be waterproof.

Transponder 10a within tag 10 is in discontinuous radio frequency communication such as indicated by arrow line A with a transponder detection system 20 mounted on the boat. Transponder detection system 20 includes at least one antenna 22, which, in a preferred embodiment, may be one or more directional antennas, cooperating with transceiver 12.

In the case of use of a single antenna, it can be an omnidirectional antenna, unidirectional antenna, or, preferably, a directional antenna, such as for example a dipole antenna or yagi antenna taught in the prior art, for increased directionality and range.

Multiple antennae 22 may also be used to increase the directionality and/or range of the system such as, for example, a phased antenna array. These directional and/or ranging antennae can enhance the ability of the operator to detect the proximity of personnel hidden from the view of the machine operator.

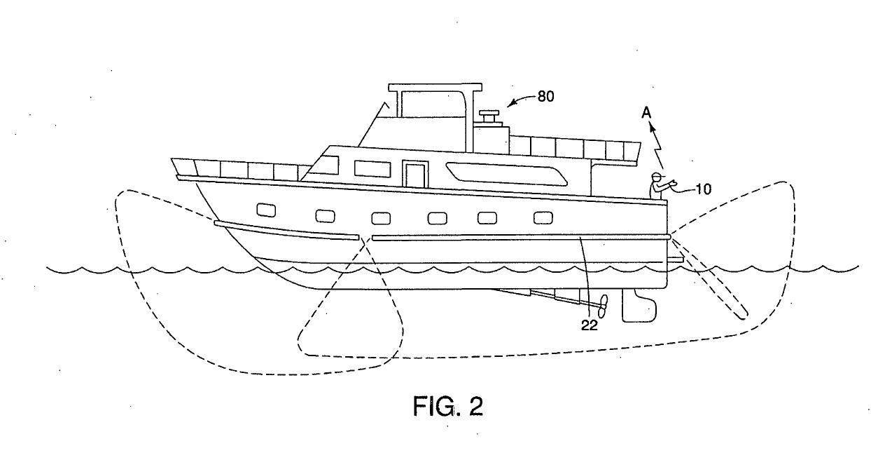

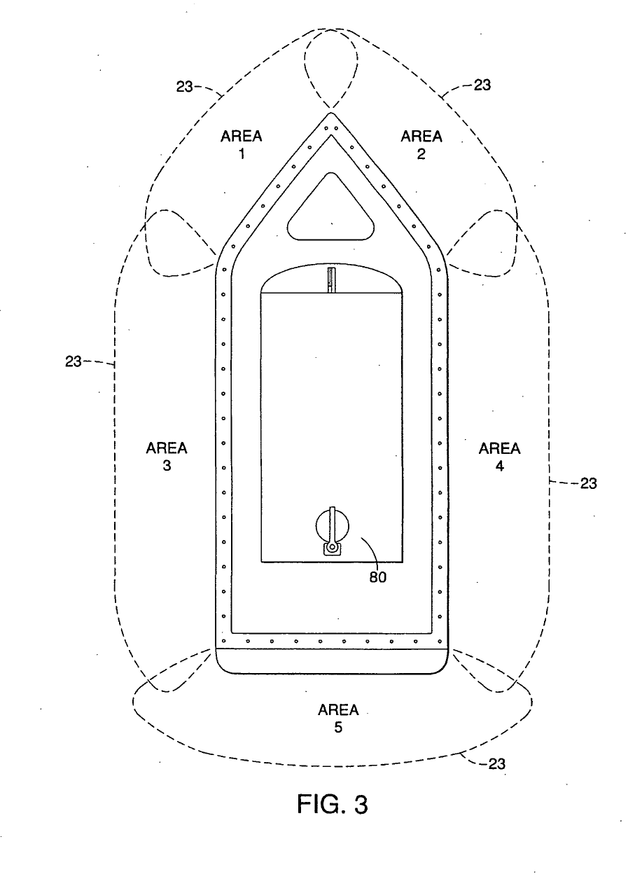

In one embodiment of the present invention, the antennae 22 may be located circumferentially around the hull of a boat above the water line as illustrated in FIG. 2. The system may include a plurality of antennae 22 each defining one area surrounding the boat as illustrated in FIG. 3. As illustrated in FIG. 3, the system may include five antennae 22 defining five detection zones 23. However, it will be appreciated that the number of antennae 22 and therefore the number and size of each detection zone 23 will depend upon the size of the boat as well as the accuracy of determining the location of the person overboard. It will be appreciated that the antennae 22 of the present embodiment will be adapted to only have a detection zone 23 extending from the hull of the boat and not include within these detection zones 23 any part of the onboard space of the boat itself. Accordingly, the antennae 22 will not activate the RFID tags 10 unless the wearer is in detection zone in the water proximate to the boat. It will be appreciated that utilizing multiple antennae 22 will permit one or more of the antennae 22 to be deactivated so as to permit in water or other activities, such as for example, loading the ship at dock or swimming to take place without activating the present system.

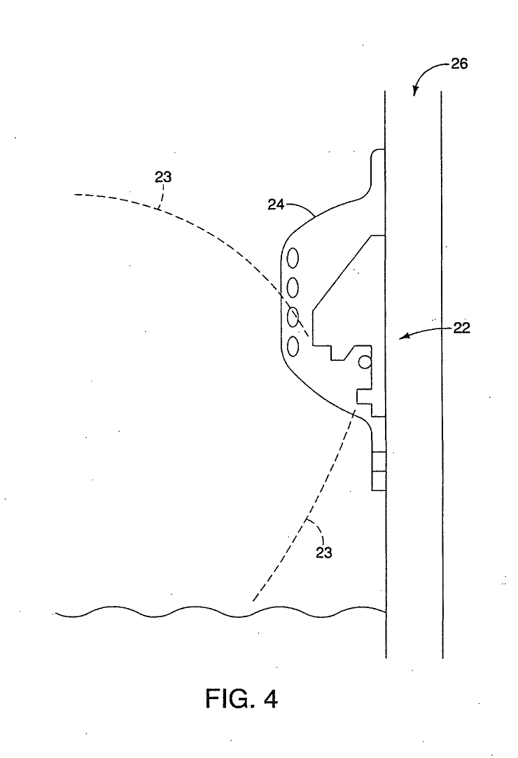

Referring to FIG. 4, the antenna 22 may be located within a rub rail casing 24 on the exterior surface of the boat bull 26. As illustrated the antenna 22 is located above the water line. It will be appreciated that for applications requiring a detection zone 23 to be larger antenna 22 may be located higher on the hull of the boat from the waterline. It will also be appreciated that for applications requiring the detection zone 23 to extend a greater distance from the boat antennae 22 may utilize greater power according to known methods. In practice it has been found that detection zone 23 distances extending up to 15 feet from the boat hull 26 have been useful although other distances may also be required.

An alert signal coming from the person's RFID tag 10 is received by the antenna 22 on the boat, routed through the transceiver 12, and then transmitted to the processor 30. In the processor 30, the signal is received by a microprocessor (not shown) that processes the signal and generates the appropriate output to a user interface such as an alarm or status display, and to a boat control system for example a PLC and actuator so as to stop the boat or initiate some other action such as to launch an emergency life preserver as described further below. The sensory alarms may be visual, auditory, or any other appropriate sensory alarm, and combinations thereof.

The outputs may further include RFID encoded data read from the person's tag 10, such as a unique identifier which may be recorded by the processor 30 in its associated memory for later replay to display, for example, the identity of the workman, and the location of the boat and person if the system is GPS equipped. These outputs can be generated by information transmitted from the person's RFID tag 10, or can be information that is stored in the processor 30 and its memory, or in a related server computer cooperating wirelessly with the processor, and which information is correlated to the unique identifier transmitted to the transponder detection system.

Additionally, the processor 30 may be designed to enable simultaneous detection of multiple tags or multiple people. In systems using multiple antennae 22, the direction of the tag's 10 movement in relation to the machine transponder detection system can be more accurately determined. The information relating to the position and direction of the tag 10 in the water may be utilized by the processor for more accurately determining the direction and distance to launch an emergency life preserver or other floatation device.

In operation, the antennae 22 outputs a signal on a continuous or intermittent basis such as for example a so-called chirp signal where frequencies vary with time. In response to a person falling overboard into one of the detection zones 23, the transponder 10a on the RFID tag 10 is activated by the signal from the antennae 22 and sends a reply signal to the antennae 22 which is then transmitted to the processor. The processor 30 determines which detection zone 23 the RFID tag 10 and therefore the person is located in and performs the necessary actions.

For example, an alarm may be sounded sound throughout the boat and an alarm may be displayed on an operator console by the alarm system 40. The processor may also display and log the area of boat where the incident occurred. The processor 30 may also cause the boat mechanical systems 42 to slow or stop the boat. The processor 30 may also direct a search lights system 44 to automatically search the activated detection zone 23. It will be appreciated that other control applications are possible. For smaller boats such as, for example, boats for use as a personal fishing boat, the processor 30 may be adapted to broadcast a mayday signal having GPS co-ordinates to the coast guard. The processor may also be adapted to drop the anchor of such a small vessel and to furl the sails of a sailing boat.

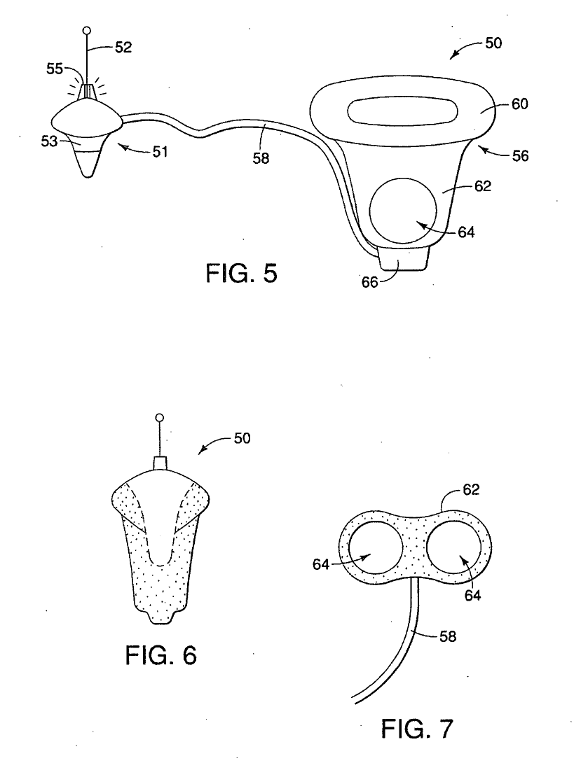

Turning now to FIG. 5, a marine safety pod system 50 is illustrated incorporating an RFID tag for use in cooperation with the transponder detection system 20. The safety pod 50 includes a radio pod 51 connected to a life preserver 56 by a tether 58. The radio pod 51 has a radio transponder 53 and an antenna 52 and optionally a strobe light 55 such as for example an LED strobe. A battery 57 for powering the radio transponder and strobe light may also be included in the radio pod 51. The life preserver includes an inflatable floatation ling 60 or other suitable structure connected to a floatation body 62 having at least one leg hole 64 therein. The life preserver 60 also includes a compressed gas source 66 for inflating the floatation ring 60. The marine safety pod 50 may have a deflated and compacted form as illustrated in FIG. 6 so as to be launchable by a boat mounted launcher 80 as illustrated in FIGS. 2 and 3, such as for example a compressed air or a launcher utilizing an explosive charge. Turning to FIG. 7, a detail of the floatation body 62 having two leg holes 64 is illustrated. As illustrated the floatation body 62 may have an inflation pull cord 68 for use by a user which is operable to cause the compressed air source 66 to inflate the floatation ring 60 when pulled. The marine safety pod 50 may also include a solar panel (not shown) for providing power to the safety pod 50 or recharging the battery 57.

Optionally, multiple frequency signals may be transmitted by the antenna 22 which may activate the RFID tag 10 so as to reduce holes and propagation errors. For example the antenna 22 may transmit, and the RFID tag 10 be operable to receive, frequencies of multiple bands or an ultra-wide band frequency as they are known to those skilled in the art. In addition, the transceiver 12 and antenna 22 may be adapted to produce a pulsed signal from the antenna 22 for use in locations where a continuous radio frequency signal would result in propagation and reflection errors. In addition, signals having frequencies that vary with time, often referred to as chirp signals, may be utilized. In particular, signals generated and transmitted by the antennae 22 may be linear chirp signals wherein the instantaneous frequency of the signal varies linearly with time or an exponential chirp type wherein the instantaneous frequency of the signal varies exponentially with time. Other types of chirp signals will be known to those of skill in the art. Methods for generating chirp signals and the like are described in more detail in U.S. Pat. Nos. 6,466,609 and 6,614,853 to Koslar et al., the disclosures of both of which are incorporated herein by reference. It will be appreciated to those of skill in the art that other methods of generating a signal having a frequency that vanes over time with the signal duration will also be useful. Other methods for generating such signals such, as chirp signals are known in the art.

As part of the method of use of the present invention, the transponder tags 10 may be tested periodically or for example once a day or before each voyage by passing the tag through an interrogator station (not shown) which tests for the one or several frequencies being employed and recognized by the transponder detection system. It will be appreciated that gangplanks and entryways may also be set-up to test system & tags every time a person passes through it on larger vessels.

As will be apparent to those skilled in the art in the light of the foregoing disclosure, many alterations and modifications are possible in the practice of this invention without departing from the spirit or scope thereof.

What is claimed is:

1. A person-overboard monitoring and alarm system, comprising: an RFID tag adapted to be worn by a user; an array of directional antennas adapted to be mounted around a perimeter of a boat hull, below and substantially parallel with a gunnel of the boat so as to be arrayed substantially above a water line of the boat and so as to provide a corresponding array of substantially distinct and independent detection zones which are substantially only directed outwardly of the boat when mounted thereon, a transceiver cooperating with said array of antennas for detecting the presence of a tag in any one of said detection zones, a processor cooperating with said transceiver for receiving signals from said transceiver upon detection of said tag in said any one of said detection zones and determining which of said detection zones contain said tag, and wherein said processor is adapted to output an alarm trigger signal to an alarm upon said detection, whereby said antenna and said transceiver substantially only detects said tag when located over-board from the boat.

2. The system of claim 1, wherein said tag contains a battery, and wherein a charge contained by the battery is conserved by an absence of active monitoring of said tag until said tag is detected in said detection zones, whereafter said tag is actively monitored and said charge of said battery is progressively depleted during said active monitoring.

3. The system of claim 2, wherein the processor is adapted to cooperate with a drive actuator of the boat and wherein upon receipt by said processor of said overboard signal the boat is caused to slow by the actuator.
